(19) United States
(12) Patent Application Publication
(10) Pub. No.: US 2014/0122213 A1
(43) Pub. Date: May 1, 2014

(54) SYSTEM AND METHOD FOR COMPARING INCENTIVE PROGRAMS

(71) Applicant: CAN I PAY LESS INC., Ottawa (CA)

(72) Inventor: Benson WONG, Ottawa (CA)

(73) Assignee: CAN I PAY LESS INC., Ottawa (CA)

(21) Appl. No.: 13/830,265

(22) Filed: Mar. 14, 2013

Related U.S. Application Data
(60) Provisional application No. 61/719,112, filed on Oct. 26, 2012.

(51) Int. Cl. G06Q 30/02

(52) U.S. Cl. CPC G06Q 30/0233
USPC 705/14.33

(57) ABSTRACT

A method of comparing reward programs is provided. The method comprises retrieving reward program benefit rules of use for a least one card from a first computing device, creating a user profile at a second computing device, calculating a cash value for each credit card of the at least one credit card, according to the user profile and the reward program benefit rules of each credit card, and displaying the cash value. The user profile comprises a user's card information and a user's desired usage of the user's at least one credit card.

### CROSS REFERENCE TO RELATED APPLICATIONS

This application claims the benefit of priority of U.S. Provisional Patent Application No. 61/719,112 filed Oct. 26, 2012, which is incorporated herein by reference in its entirety.

### TECHNICAL FIELD

The present disclosure relates generally to systems and methods for providing information and/or recommendations regarding consumer decisions. More particularly, the disclosure relates to systems and methods for analyzing and comparing alternative products or services.

### BACKGROUND

During times of economic uncertainty, it is important for consumers to be conscientious of their spending. The everyday spending of an individual is important because over time the costs of spending will add up to a large amount. Everyday purchases such as gas and groceries will have a large impact on the consumers' overall spending.

Heretofore, equipment has been deployed at point of sale (POS) machines that help consumers choose an optimal payment method at the time of purchase. For example, United States Patent Application US 2009/0018955 A1, “METHOD AND APPARATUS FOR PROVIDING USER ACCESS TO PAYMENT METHODS”, describes a point of sale apparatus that compare available payment methods and recommend payment methods to the user.

United States Patent Application US 2011/0218884 A1, “PAYMENT METHOD DECISION ENGINE”, provides a method for choosing an optimal payment for a purchase; however, the disclosure is directed to providing recommendations for individual purchases at the point of sale online.

### SUMMARY

None of the systems referred to above address the problem that payment methods are more effectively chosen before the point of sale, and that by comparing payment methods outside of an individual purchase, the consumer is not limited to the category of immediate purchases. Thus, the consumers' existing rewards, spending habits, and credit card preferences can be taken into account, and the consumer has access to more choice and those choices may interact with other payment methods which if calculated correctly will translate to more savings. During a purchase, the consumers' choice of payment methods is limited to those immediately available, either in immediate possession of the user or through a store's accessible payment methods. For example, an accessible payment method is an instant department store credit card approval.

Every payment method is different in some way and their interactions with each other are also different. Furthermore, none of the systems referred to above address the willingness of consumers to carry multiple payment methods, and that it is possible to exploit the interaction of competing payment methods. The present invention compares combinations of payment methods prior to point of sale that would provide the user with the highest savings through a combination of payment methods.

Accordingly, some embodiments disclosed herein relate to a system including a central processor and remote terminals wherein there is a method for comparing payment methods and interaction thereof with each other to produce an optimal combination of payment methods independent of any immediate purchase decision.

Some embodiments described herein provide an internet service which collects a user profile and finds alternative products based on their specified parameters. By searching for alternative products, the user can achieve a better price or piece of mind that they have indeed made the correct purchase.

Some embodiments described herein improve state of the art searches by converting any rewards to an equivalent cash value, and comparing products on the easily understood platform of cash value.

Consumers who choose to pay for their purchases with a credit card and pay off their credit card balance before any interest can be charged can see significant annual savings through their chosen credit card benefits. Many consumers are willing to carry multiple credit cards to maximize the potential cash value of the optimal payment method, and as more credit cards become available with different benefits and interactions, finding the optimal combination of cards becomes a difficulty for consumers. Some embodiments described herein simplify the experience of finding the best card or combination of cards by collecting a user profile and calculating the best combination of cards.

Some embodiments described herein, based on a user profile (submitted by user), show the potential earnings achieved by switching credit card (or cards, for two card, three card combinations, or more) in terms of cash value.

Some embodiments described herein, based on a user profile, equally spread out any acute credit card bonus, promotions, or benefits over the length of the credit card's life to achieve an average yearly cash value.

Some embodiments described herein, based on a user profile, convert any form of rewards to an equivalent cash value to achieve an equal comparison platform.

Some embodiments described herein, based on a user profile, compare and calculate the cash values of combinations of credit cards, debit cards or debit and credit cards.

Some embodiments described herein, for each combination of cards, compare the cash value of the combination being used in different ways. Some embodiments also show the strategy used to the user, by for example, displaying an indication of the strategy on a display of the user's computing device where the strategy may involve using suggested card A for purchases in one spending category, and card B for purchases in all other spending categories.

Some embodiments described herein, collect information on spending categories (e.g. gas, groceries, restaurants, entertainment, bills, travel, etc . . . ) and use these values to create a user profile.

Some embodiments described herein, based on an available rewards program (and, in some embodiments, additional information such as for example but not limited to the user profile), convert the alternate currency into the posted gas price metric (for example but not limited to cents per liter, dollars per gallon) and reduce the posted gas price by this calculated amount. Throughout the disclosure gas is used as a non-limiting illustrative example only and other forms of fuels are also applicable.

Some embodiments described herein, based on a payment method (assumed, provided, or inferred) reduce the posted gas price by the effective savings rate for gas spending.

Some embodiments described herein, display the effective gas price with the strategy used to achieve the effective gas price, shown side by side with the starting gas price.

Some embodiments described herein, based on savings calculations, display the calculations in an easy to understand text format on, for example, a display of the user's computing device.

Some embodiments described herein notify users of calculated savings based on their stored user profile and new promotions or products.

Some embodiments described herein, based on one-time or irregular spending, allow estimations of a trip cost or budget to be calculated on a per year basis.

Some embodiments described herein use average consumer spending (gathered from for example but not limited to statscan, usgov, or other statistics agencies) values to seed initial user values.

Some embodiments described herein compare products from a visible selection of providers with the option of excluding undesirable providers.

Some embodiments described herein generate an exportable report for the user regarding what benefits are included in their credit card combination (e.g. medical insurance, gas cash back rates, yearly included hotel stays, etc.).

Some embodiments described herein provide a computer database comprising all credit card providers and allows the user to exclude any providers chosen by the user.

Some embodiments described herein further takes into account the compatibility of additional benefits offered by the credit cards. In further embodiments, additional benefits comprise extended warranty, purchase assurance, price protection, medical insurance, travel accident insurance, trip cancellation insurance, trip interruption insurance, flight delay insurance, baggage loss or delay insurance, car rental insurance, fuel cash back rates, groceries cash back rates, entertainment cash back rates, quarterly cash back bonus rates, bill payment cash back rates, restaurant cash back rates, drug store cash back rates, yearly included hotel stays, first year of no fees, bonuses for signing up for a service, bonuses for using a service, all other credit card spending, or combinations thereof. Some embodiments described herein provide a conversion rate comprising a point to currency conversion rate for point redemptions to purchase flights, hotel stays, trips, cash, credit, gift cards, and other merchandise.

Some embodiments described herein calculate based on an amount of monthly spending of the user in the categories of fuel, groceries, restaurants, bills, travel and miscellaneous.

Some embodiments described herein calculate based on any annual fees, promotional or welcome bonuses, spending bonuses, annual benefits that are offered with the reward program.

Some embodiments described herein generate an exportable report for the user based on all benefits that are included in the potential cash value.

Other aspects and features of the present disclosure will become apparent to those ordinarily skilled in the art upon review of the following description of specific embodiments in conjunction with the accompanying figures.

### BRIEF DESCRIPTION OF THE DRAWINGS

In order to provide a further understanding of the embodiments described herein the following figures have been provided. These figures are intended to be examples only and should not be construed as limiting the scope of the invention.

FIG. 1 is a flowchart diagram illustrating a method for calculating credit card benefits, according to an embodiment of the present invention.

FIG. 2 is a flowchart diagram illustrating a method for calculating and showing effective gas prices, according to an embodiment of the present invention.

FIG. 3 is a diagram illustrating a system for implementing a client-server system according to an embodiment of the present invention, where the client or user connects to the internet to access a server.

### DETAILED DESCRIPTION

Some embodiments described herein relate to systems and methods for comparing alternative products or services. Some embodiments provide information and/or recommendations to allow a consumer to reduce spending on consumer products or services without compromising on consumer needs.

Reward programs have their true cash value obfuscated through various redemption rates and values where typically a larger redemption leads to higher point value. Most major gas retailers provide an reward to fill up at their gas stations. When considering the posted gas price and the reward programs value reduced from the posted gas price, the effective best gas price becomes difficult to identify.

Known systems have limitations that are improved upon by some embodiments described herein. United States Patent Application US2012/0116747 relates to recommending alternatives for providing a service wherein services are monitored and when a new event occurs, it is analyzed in order to provide a recommendation to the client based on the available services. Some embodiments described herein provide an improvement because as users have multiple methods of payments to consider when their payment methods are in their possession, they have even more payment methods to choose from when deciding on which payment method should be owned or applied for and focus on the interactions of payment methods both owned or available for daily use where the prior art is limited by what is immediately available in the users wallet for the current purchase.

A typical credit card will often offer rewards to a user in order to attract the user to sign up and use their credit card. For example, some credit cards offer a percentage of the cash amount applied to the credit card back to the user, while some credits cards offer points which can be collected and redeemed for gifts cards, flights, or selected merchandise. However, these credit cards are currently being compared in unequal terms, i.e. cash value versus a point system.

While some consumers will try to be conscientious about getting the lowest price, for example the lowest posted gas price, some consumers do not take into consideration certain rewards programs or the equivalent cash value that they would get from the credit card that they use.

In the present disclosure, a reward program can refer to one or more of any program (for example, a reward program, a loyalty program or an incentive program) that offers rewards associated with a financial transaction. Financial transaction is associated with a vendor and a credit card, a debit card, a loyalty card, or any other identifier for a financial transaction. The present disclosure refers to various cards, such as credit cards and debit cards; however, the present disclosure should be read such that a “card” refers generally to any form of payment using a means of identification. Forms of identification include, for example, a credit card number, a debit card number, a personal identification number (PIN), an account number, a rewards program number and a gift card serial number.

A reward can include, for example, points, loyalty benefits, miles, cash back, rebates, savings, any alternate currency, insurance, gas cash back rates, yearly included hotel stay, discounts, incentives, welcome bonus, merchandise and fee reductions. An insurance type reward can include, for example, an extended warranty, purchase assurance, price protection, medical insurance, travel accident insurance, trip cancellation insurance, trip interruption insurance, flight delay insurance, baggage loss or delay insurance, and car rental insurance.

Reward programs each have their own strengths and weaknesses and comparing each program against each other requires more computations than most consumers are willing to do. Comparing combinations of reward programs working together requires exponentially more calculations. For example among n reward credit cards, where n is the number of credit cards to be compared and x is the number of operations to satisfy a credit cards behavior and logic, a user must compute (x) times (n) calculations to find the best valued card. If the user wants to carry 2 credit cards then that will be (x) times (n) times (n−1) calculations. If the user wants to carry 3 credit cards then that will be (x) times (n) times (n−1) times (n−2) calculations.

Most users have multiple credit cards in order to get the benefits from the reward programs offered from the credit cards. For example, a user might have a specific credit card that they use at a specific store, or a specific credit card that they use for high value purchases. Since some credit card rewards offer more value in certain areas than other credit cards, it is difficult for a user to know what specific combination of credit cards will offer the most benefit to themselves.

In view of the foregoing, it would be desirable to provide the user with a system which provides the most complete understanding of credit card rewards and their interactions with other reward programs.

Therefore, a method of comparing reward programs is provided. The method comprises retrieving reward program benefit rules of use for a least one card from a first computing device, creating a user profile at a second computing device, calculating a cash value for each credit card of the at least one credit card, according to the user profile and the reward program benefit rules of each credit card, and displaying the cash value. The user profile comprises a user's card information and a user's desired usage of the user's at least one credit card.

Some embodiments of the present disclosure provide a system for evaluating a plurality of credit card benefits against contrasting pluralities of credit cards and their benefits. Numerous details are set forth to provide an understanding of the examples described herein. The examples may be practiced without these details. In other instances, well-known methods, procedures, and components are not described in detail to avoid obscuring the examples described. The description is not to be considered as limited to the scope of the examples described herein.

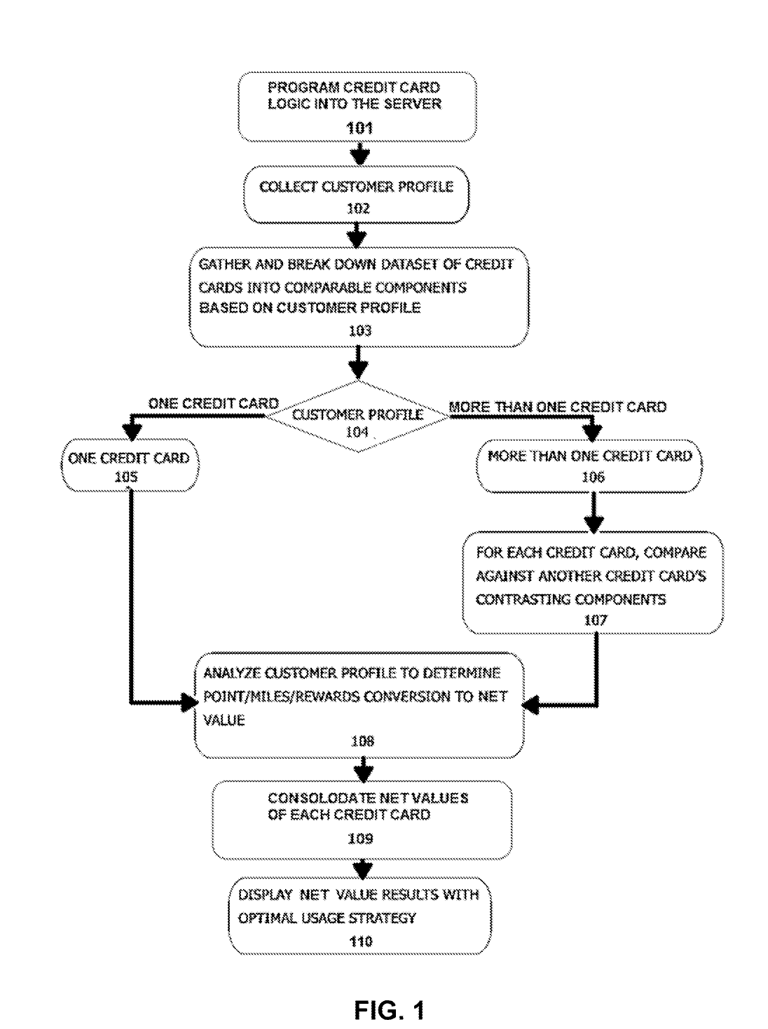

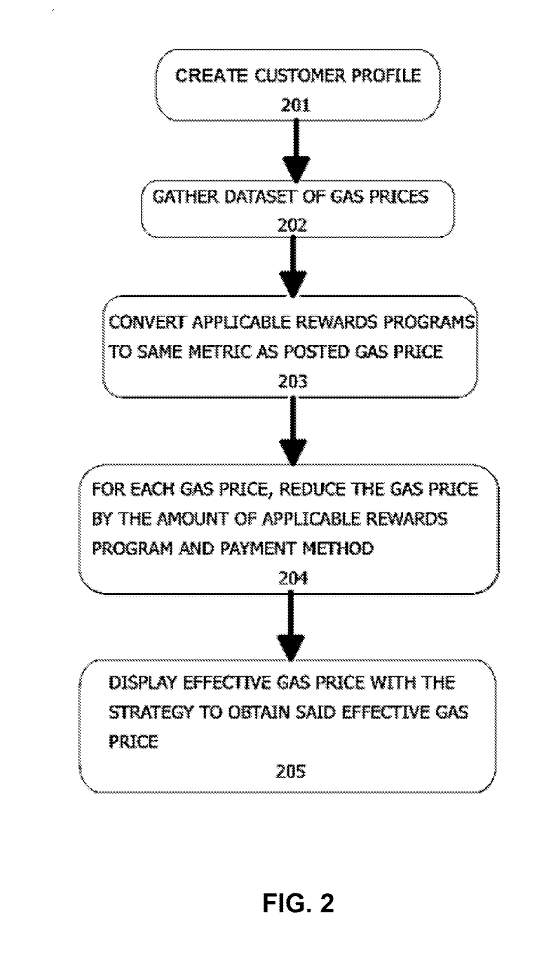

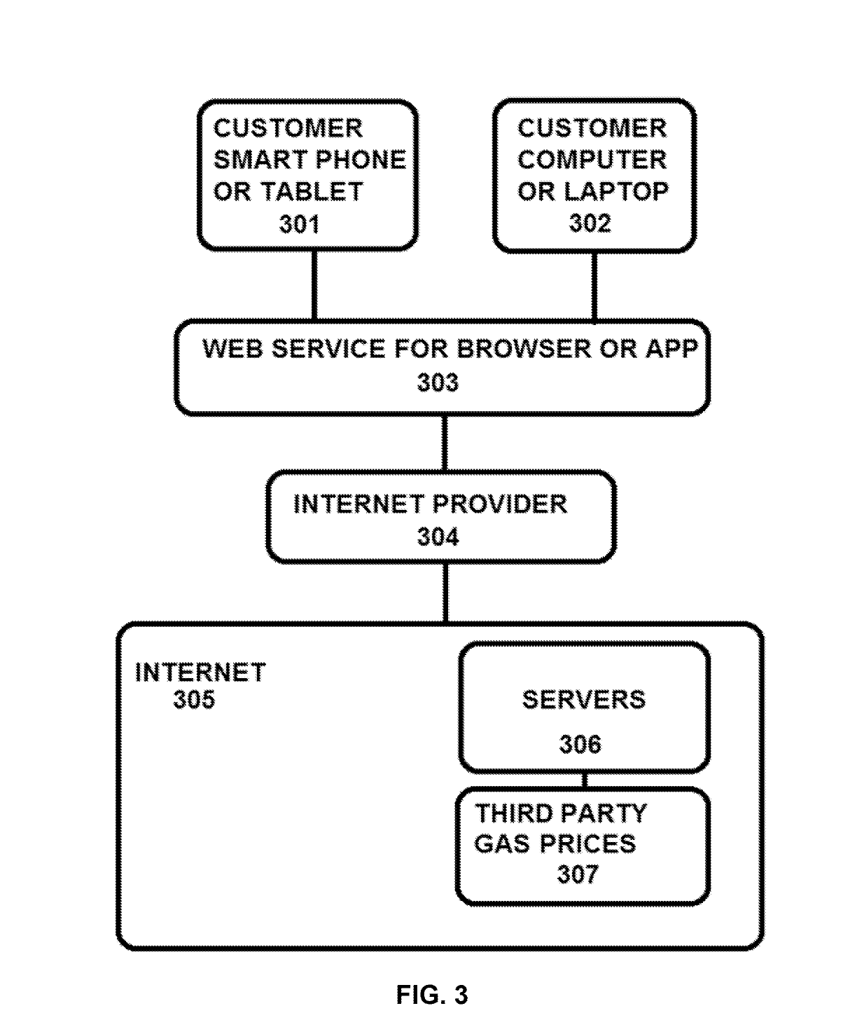

Various embodiments described herein relate to an electronic device including at least one processor and a computer-readable medium, such as a non-transitory computer-readable medium. Some of these embodiments are configured to execute the method of FIG. 1. Some other of these embodiments are configured to execute the method of FIG. 2 and/or the system of FIG. 3.

FIG. 1 is a flowchart diagram illustrating a method for evaluating and calculating credit card benefits, in accordance with an embodiment of the invention. The method may be carried out by software executed by, for example, a processor of an electronic device. Coding of software for carrying out such a method is within the scope of a person of ordinary skill in the art given the present description. The method may contain additional or fewer processes than shown and/or described, and may be performed in a different order. Computer-readable code executable by at least one processor of an electronic device to perform the method may be stored in a computer-readable medium, such as a non-transitory computer-readable medium.

FIG. 1 illustrates an example of considerations that are used to make an accurate credit card evaluation, the process of evaluating credit card benefits, and the steps to calculate cash value which will be displayed to the user. First, the logic of all credit cards is programmed into a server 101. Every credit card has different rules of use, the logic of the credit cards refers to the rules of use of the credit card such as, but not limited to, cash back, reward points, annual bonuses, etc. A non-limiting example of the logic of a credit card would be that a credit card may offer 2% cash back on gas purchases, 1% cash back on all other purchases, and a $100 bonus after the first year of using the credit card. Each rule of use (i.e. logic) of each credit card is programmed into a computer using computer language.

Second, at 102 a user submits information to the client and the invention builds a user profile. In various embodiment, the user profile includes one or more of the following: the geographical location of the user, the names of any credit cards currently used by the user, the length of time that the user typically uses the credit card, the number of credit cards the user would like to use, whether there are any preferences to which credit card network to be used (for example: Visa, MasterCard, American Express, etc.), the monthly or yearly spending habits of the user in the form of currency (for example in the categories of gas, groceries, restaurants, entertainment, bills, travel, drug stores, and miscellaneous), the names of any stores of which they would like to have a loyalty program, any point redemption preferences (for example: gift cards, flights, merchandise, hotel stays, etc.), any preferences on included credit card benefits (for example: extended warranty, purchase assurance, price protection, return protection, event ticket protection, medical protection, travel accident protection, trip cancellation insurance, flight delay insurance, baggage loss or delay insurance, car rental insurance, etc.) and a list of banks they prefer or explicitly do not want to interact with.

In some embodiments, the user profile considers the existing payment methods the user already owns and provides a contrasted comparison to the user showing the resulting rewards from the existing payment methods and showing alternative reward programs. In an embodiment, the alternative reward programs comprise all forms of payment available to user known to the system of the present disclosure. In a further embodiment, the alternative reward programs comprise a subset of all forms of payment available based on a user-specified maximum number of payment methods. The comparison between the rewards available from the user's existing payment methods, and between the rewards potentially available from the larger set of all available payment methods, is determined on the basis of comparing the equivalent cash value between the two groups of payment methods.

Third, at 103 a relevant dataset of credit cards is identified. The dataset is based on the user's location and any preferences entered into the user profile. Any eligible credit card for the user's location is included in the dataset and any credit card that does not meet the user's profile is excluded. The client asks the server for the relevant dataset from the credit cards which have been programmed into the server from 101 and the server sends the required logic to the client for calculation comparisons.

Based on the dataset of credit cards the component cash values of each credit card is calculated at 103. As a non-limiting example, components may include welcome bonuses, anniversary bonuses, any possible fees, benefits of spending in the category of gas, benefits of spending in the category of groceries, benefits of spending in the category of restaurants, benefits of spending in the category of bills, benefits of spending in the category of travel, benefits of spending in the category of entertainment, all other spending benefits, any of the benefits included in the user profile, point conversion rates that are calculated based on redemption preference and the value of the point system. In the case of a welcome bonus where the first annual fee is waived then the logic of the credit card programmed into the server is that the user pays the fee every year, including the first year, but the value of the first fee is credited to the user. In another case, merchandise welcome bonuses, (for example a new phone or a free night stay at a hotel) are given an equivalent cash value. The component cash values are calculated by the client based on the logic received from the server. For example, if a user submitted to the client that they spend $1000/month total, then they would receive $10/month back in the form of a rebate if they were using a credit card that offers 1% cash back on all purchases.

At 104, a determination is made if calculations for a user who plans to use one credit card are needed or a user with plans to use more than one credit card. If the user indicates the intention of using one credit card, the user is brought through 105. Each credit card has their components compiled to result in a cash value or if the credit card has its own point system, then the cash value of the point system for each credit card is calculated.

In the case of the credit card having its own point system then the point value is converted into a cash value based on the point redemption preferences that the user has previously indicated in the user profile 108. For example, a credit card may offer 1 point for every dollar that a user spends. A user can then redeem their accumulated points for item(s) such as flights, cash, merchandise, etc. The value of the points of the credit card is calculated based on the cash value the item(s) that the user redeems their points for. If a flight cost $1000 and the user needs 100,000 points to redeem that flight then the value of each point is $0.01/point. If the user decides to redeem their points for merchandise then the value of the points may be different. For example, the user may need 10,000 points to redeem a $50 gift card which would give a point value of $0.005/point.

At 106, the calculated cash value then becomes the net value. At 109, the net value of all the credit cards in the relevant dataset of credit cards is then ranked in order of highest net value to lowest net value.

If the user indicates the intention of using more than one credit card 106, the invention uses each credit card's component and combination of components in the calculated dataset and compares the dataset of components of each and every credit card against contrasting credit cards and their contrasting components 107. Some embodiments include client side software that considers every mathematical combination of credit cards (e.g. for cards A B C and D we try AB, AC, AD, BC, BD, and CD for two card combinations, and we try ABC, ABD, ACD, and BCD for three card combinations). For each combination of credit cards the components of the credit cards are compared, each combination of components is compared and calculated. In this way, each component appears at least once in the comparison and calculation. For example, of cards A and B and components 1, 2, 3, 4, 5, and 6 combinations A1A2A3A4A5B6, A1A2A3A4B5A6, A1A2A3B4A5A6, A1A2B3A4A5A6, A1B2A3A4A5A6, B1A2A3A4A5A6, A1A2A3A4B5B6, etc. are calculated and compared. For each credit card combination and credit card component combination, the component values of the credit cards that are used in the combination are recalculated in order to accurately calculate the interaction of the combination of credit cards based on the logic of the credit cards in the combination. For example, if a spending threshold for a credit card is no longer met due to splitting the total amount spent among multiple credit cards, then a reward or bonus may be different. The components are then consolidated, which results in a cash value and/or point value for each combination of credit cards, if the credit card has its own point system. In the case of the credit card having its own point system then the point value is converted, as described above, into a cash value based on the point redemption preferences that the user has previously indicated in the user profile 108. The calculated cash value then becomes the net value. In 109, the net value of all the combinations of credit cards is then ranked in order of highest net value to lowest net value.

Finally, when all calculations have been made for either a single credit card or multiple credit cards, then at 110 the net value results, the results comprising a detailed strategy on how the credit cards were used to optimize the net value and how the net value was calculated, is displayed on, for example, the display of the user's computing device.

If the user provides their current credit card or credit cards then some embodiments will also display the rebate value that the user is currently receiving so that the user can compare their current rebate value to the net value results achieved by the invention. Some embodiments also display the cash value of their current credit card or credit cards based on their user profile and may highlight the value of adding, removing, or replacing credit cards from their list of owned credit cards.

FIG. 2 is a flowchart diagram illustrating a method for calculating and contrasting an effective fuel price after available reductions in price are made, in accordance with an embodiment of the invention. The embodiments described herein are not limited to a particular fuel type. For purposes of illustration, gas will be discussed though other fuel types could be used including but not limited to hydrogen, ethanol, crop based fuels and electrical energy. The method may be carried out by software executed by, for example, on a processor of an electronic device. Coding of software for carrying out such a method is within the scope of a person of ordinary skill in the art given the present description. The method may contain additional or fewer processes than shown and/or described, and may be performed in a different order. Computer-readable code executable by at least one processor of an electronic device to perform the method may be stored in a computer-readable medium, such as a non-transitory computer-readable medium.

FIG. 2 illustrates an example of considerations that can be used to make a gas price adjustment to produce an effective gas price which will be displayed to users to highlight savings and contrast posted gas prices. Based on the location of the user determined by Internet Protocol, user submission, user profile, or inferred, a user profile is created 201. The user profile comprises the location of the user (country, province/state, city, or GPS location), a list of which rewards/loyalty programs they use or would like to use, the time of day they are most likely to buy gas (e.g. after work), which credit card they would use for gas payments or a credit card that our invention has suggested (as described above), and any price adjustments for gas purchases based on the payment method. In some embodiments, the credit card information is only included in the user profile if the user has completed their user profile for the credit card evaluation, as described above.

Based on the location of the user, a gas price dataset is gathered from a database containing displayed gas prices 202. The database is one or more publically available application programming interfaces which provide a feed into their database of gas prices which are collected from user submissions based on their local sightings.

Based on the user profile and available rewards programs the local gas stations may offer, a first adjustment value is determined under the same metric as the posted gas price 203. The adjustment value is determined by converting the available program into the same metric as the posted gas price. For example, if a gas station offers 1 reward point per litre and 100 reward points can be redeemed for $1, then the adjustment value would be 1 cent per litre discount. Based on the user profile and the available purchase methods of the user, a second adjustment value is determined under the same metric as the posted gas price. Some payment methods offer a discount or cash back for gas purchases, the discount or cash back is either directly taken from the credit card logic if the credit card explicitly states a bonus for gas purchases (for example, a 3% cash back on gas purchases), or a calculated adjustment (for example, if a card offers a 4% cash back on gas purchases with a $99 yearly fee and the user profile indicates this user spends $100 on gas each month out of $1000 of monthly overall spending then we take the gas cash back component and weight it against the overall cash back value to find a percentage cash back per gas component spending). If the user has not completed the credit card evaluation and no credit card information is present then it is assumed that the user is paying with cash or debit card. In the case where it is assumed that the user is paying with cash or debit card then some embodiments may also suggest to the user a possible payment method to increase their rebate from gas purchases.

The posted gas prices of all the gas stations in the gas price dataset are then reduced by the first and second adjustment value to achieve an effective gas price 204.

For each displayed posted gas price, some embodiments will post a strategy to optimize available programs and payment methods and relate said strategy to the effective gas price 205. An example of a strategy would be using loyalty card A with payment method B at gas station number 1 versus using payment method C at gas station number 2.

FIG. 3 is a diagram illustrating a system that implements a client server system where the client or user connects to the internet to access the invention's server. For purposes of illustration, a simplified client is represented by 301 and/or 302 where the user uses a laptop, desktop computer, mobile phone, tablet, or any other computing or mobile communication device as the client interface. Each client has software that is capable of accessing internet services through either a web browser or application (or app) 303. The web browser communicates with an internet service provider 304 which allows the client to communicate with the internet 305. The servers which are available through internet access 306 may interact with the internet and other third party services such as third party gas prices 307. The servers then gather the data that is to be sent back to the user client, and sends the information through the internet to reach the initiating client from 301 and/or 302. In some embodiments, software loaded on the server(s) 306 access third party gas prices 307. The software would allow the server 306 to execute, for example, the method of FIG. 2. The server 306 then sends any stored or calculated information through the internet 305 to an internet provider 304 which then sends information to a web browser 303, the web browser 303 can be on a phone 301, tablet 301, computer 302, laptop 302 or any other computing or mobile communication device. The server(s) 306 include a processor and a memory device, such as a non-transitory memory device.

Embodiments of the disclosure can be represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a diskette, compact disk read only memory (CD-ROM), memory device (volatile or non-volatile), or similar storage mechanism. The machine-readable medium can contain various sets of instructions, code sequences, configuration information, or other data, which, when executed, cause a processor to perform steps in a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor or other suitable processing device, and can interface with circuitry to perform the described tasks.

The present disclosure may be embodied in other specific forms without departing from its spirit or essential characteristics. The described embodiments are to be considered in all respects only as illustrative and not restrictive. The scope of the disclosure is, therefore, indicated by the appended claims rather than by the foregoing description. All changes that come within the meaning and range of equivalency of the claims are to be embraced within their scope.

What is claimed is:

1. A method of comparing reward programs comprising:
retrieving reward program benefit rules of use for a least one card from a first computing device;
creating a user profile at a second computing device, the user profile comprising a user's card information and a user's desired usage of the user's at least one credit card;
calculating a cash value of the rewards for each credit card of the at least one credit card, according to the user profile and the reward program benefit rules of each credit card; and
displaying the cash value of the rewards.

2. The method of claim 1 wherein the user profile comprises a desired usage of more than one card and further comprising the steps of:
identifying a number of desired credit cards for use;
generating a plurality of unique credit card combinations, each combination size equaling the number of desired credit cards for use;
calculating a cash value for each unique credit card combination of the plurality of unique credit card combinations, according to the user profile and a combined reward program benefits rules of use for the unique credit card combination; and
displaying the cash value.

3. The method of claim 1 wherein calculating comprises converting non-monetary points of the reward program to the cash value.

4. The method of claim 3 wherein the converting comprises use of a point to currency conversion rate for point redemptions.

5. The method of claim 1 wherein the user profile comprises a rate of spending by the user.

6. The method of claim 1 wherein calculating comprises spreading out a non-recurring reward program benefit over a period of time.

7. The method of claim 1 wherein calculating the cash value comprises calculating annual fees, bonuses and annual benefits that are offered with the reward program.

8. The method of claim 1 wherein displaying further comprises displaying the calculations used to calculate the cash value.

9. The method of claim 1 further comprising:
updating the reward program benefit rules for a least one credit card;
calculating an updated cash value for each credit card of the at least one credit card, according to the user profile and the reward program benefit rules of each credit card; and
displaying the updated cash value.

10. The method of claim 5 wherein the user profile comprises a dollar value of amount spent per month.

11. The method of claim 10 wherein the dollar value is based on irregular spending and is averaged over one year.

12. The method of claim 1 wherein the user profile is seeded with average consumer spending values.

13. The method of claim 1 further comprising:
calculating a first cash value for a first of the at least one credit card;
calculating a second cash value for a second of the at least one credit card; and
displaying a difference between the first cash value and the second cash value.

14. A system comprising:
a computer processor;
a computer memory device, said computer memory device being operatively coupled to said computer processor, said computer memory device including programs and instructions for executing the method of claim 1.

15. A computer-readable storage medium having computer-readable code executable by a processor of an electronic device to perform the method of claim 1.

16. A method for comparing a fuel price, the method comprising:
determining a location of a user based on information provided at a first computing device;
gathering a dataset of fuel providers at a second computing device, each fuel provider comprising a first fuel price;
identifying a plurality of payment options for each fuel provider;
calculating a second fuel price for each combination of fuel provider and payment option; and
displaying the second fuel price.

17. The method of claim 16 wherein gathering comprises determining the location of the fuel provider in relation to the location of the user.

18. The method of claim 16 wherein the step of calculating comprises converting a non-monetary point reward.

19. A system comprising:
a computer processor;
a computer memory device, said computer memory device being operatively coupled to said computer processor, said computer memory device including programs and instructions for executing the method of claim 16.

20. A computer-readable storage medium having computer-readable code executable by a processor of an electronic device to perform the method of claim 16.
